(19) United States
(12) Patent Application Publication
(10) Pub. No.: US 2010/0223069 A1
(43) Pub. Date: Sep. 2, 2010

(54) METHOD FOR MONITORING ERROR IN PRESCRIPTION DATA EMPLOYING BARCODE SYSTEM

(75) Inventor: Dong Sun Kim, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignees: Dong Sun KIM, Seoul (KR); EDB CO., LTD., Seoul (KR)

(21) Appl. No.: 12/680,605

(22) PCT Filed: Sep. 29, 2007
(86) PCT No.: PCT/KR07/04775

§ 371 Date: Mar. 29, 2010

(51) Int. Cl. G06Q 10/00; G06Q 50/00; G06F 17/30; G08B 21/00

(52) U.S. Cl. 705/2; 235/375; 707/769; 340/540; 707/E17.014

(57) ABSTRACT

The present invention relates to a method for monitoring error in prescription data employing barcode system comprising the steps of recording a dosage type and dose of a medicament in a prescription order by way of encoding those in a form of barcode, inputting information recorded in the barcode-prescription order, comparing the information with a database information about the prescribed medicament, and displaying the appropriateness of the dosage type and dose of the medicament. In accordance with the method for monitoring error in prescription data employing barcode system of the invention, the error in prescription data including dosage types and doses of prescribed medicaments can be reconsidered, which makes possible its practical application for the treatment of diseases in a more safe manner.

### TECHNICAL FIELD

The present invention relates to a method for monitoring error in prescription data employing barcode system, more particularly, to a method for monitoring error in prescription data employing barcode system comprising the steps of recording dosage type and dose of a medicament in a prescription order by encoding those in a form of barcode, inputting the barcode information into a computer, comparing the inputted information with database information of the medicament so as to reconsider the appropriateness of the dosage type and dose of the prescribed medicament.

### BACKGROUND ART

As the separation of dispensary from medical practice progresses, a prescription order is issued by a doctor at hospital and a patient is provided with medicaments by a pharmacist at pharmacy on the basis of the prescription order. Thus, medicaments are prescribed by the pharmacist as per the prescription order without diagnosing the patient's disease condition, which may cause serious problems owing to the error in prescription data. For example, when a doctor describes the dosage type or dose of a prescribed medicament after diagnosing a patient's disease condition, the error in a prescription data may be inadvertently incorporated therein, which, in turn, may cause serious medical accidents.

Naturally, doctors take precautions against the medical accidents caused by the error in prescription data and make efforts to prevent the error in the course of prescription. In an effort to prevent the prescription errors, most of the prescription data which are recorded by the doctors at hospital have been replaced with electronic chart, which contributes to reduce the possibility of medical accidents. However, such a solution was not significant and not substantial in comparison to the efforts to resolve the errors in the course of prescription. If monitoring system for dosage type and dose of a medicament prescribed by doctor can be established, it can prevent medical accidents caused by the error in prescription data, however, suitable resolution has not been suggested in the art yet.

Under the circumstances, there are strong reasons for exploring and developing a method for monitoring errors recorded in prescription order issued by doctor.

### DISCLOSURE

### Technical Problem

The present inventor has made an effort to develop a method for monitoring error recorded in prescription order issued by doctor, and found that the error in prescription data can be successfully monitored by recording dosage type and dose of a medicament by way of encoding those in a form of barcode, inputting the information recorded in a prescription order by using a barcode input device, and decoding the information to transform it into the dosage type and dose of a medicament, comparing the information with a database information about dosage type and dose of the said medicament, and, in case of occurring prescription error, requesting a doctor who issued the prescription order to reconsider the dosage type and dose of the prescribed medicament.

### Technical Solution

A primary object of present invention is, therefore, to provide a method for monitoring error in prescription data recorded in a prescription order by employing barcode system.

### Advantageous Effects

In accordance with the method for monitoring error in prescription data employing barcode system of the invention, the error in prescription data including dosage types and doses of prescribed medicaments can be reconsidered, which makes possible its practical application for the treatment of diseases in a more safe manner.

### DESCRIPTION OF DRAWINGS

The above and the other objects and features of the present invention will become apparent from the following descriptions given in conjunction with the accompanying drawings, in which:

FIG. 1 shows an example of a prescription order(written in Korean language) on which a two-dimensional barcode is recorded.

FIG. 2 is a schematic diagram depicting a total flow of monitoring error in prescription data employing barcode system in accordance with the present invention.

FIG. 3 is a flow diagram depicting a way of confirming the appropriateness of dosage type and dose of a medicament prescribed by a doctor.

FIG. 4 is a schematic diagram showing an embodiment of a method for monitoring error in prescription data employing barcode system in accordance with the present invention.

### MODE FOR INVENTION

The most simple and efficient way of monitoring error in prescription data recorded in a prescription order is, to reconsider dosage types and doses of medicaments described in the prescription order by doctors or to check them by pharmacists. However, it has not been realistic in the pertinent area, since all of the medicaments can not be reconsidered by the doctors or checked by the pharmacists.

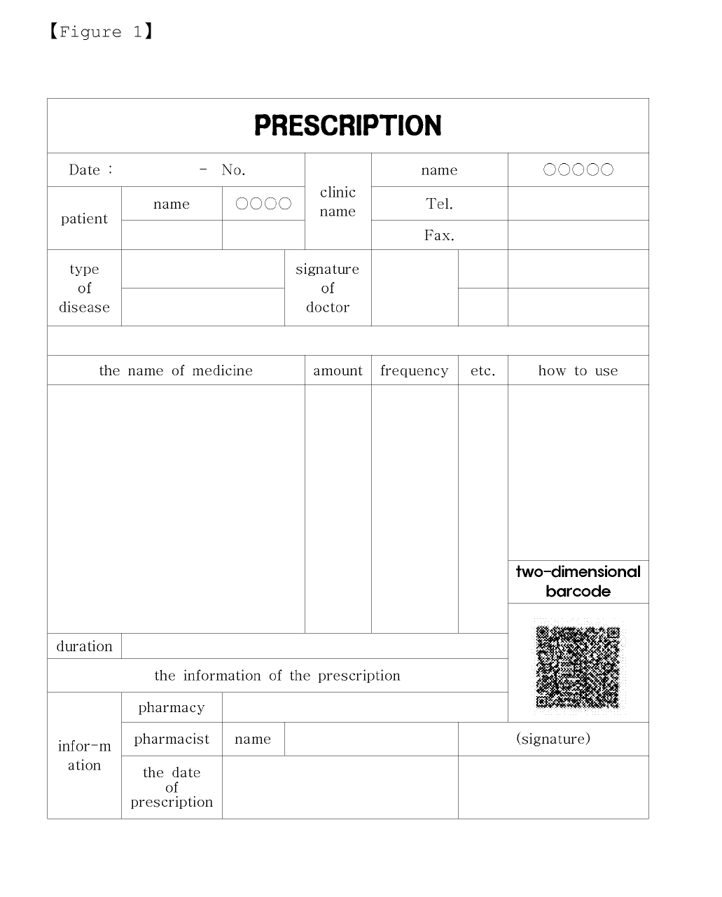

In this connection, an alternative method is suggested in the art, which is practiced by encoding dosage types and doses of medicaments described in a prescription order in a form of two-dimensional barcode, and then printing out the encoded barcode data in the prescription order. Two-dimensional barcode, which is capable of recording 1,000 letters in an area of 2.0 cm×2.0 cm, can accommodate all of dosage types and doses of medicaments described in a prescription order (see: FIG. 1). FIG. 1 shows an example of a prescription order (written in Korean language) on which a two-dimensional barcode is recorded. However, the errors caused in the course of preparing the prescription order cannot be resolved, even though all of dosage types and doses of medicaments can be recorded by two-dimensional barcode.

Under the circumstances, the present inventor has continued efforts to resolve the above problem, and proposed a method for comparing the information about dosage types and doses of medicaments recorded in a form of a two-dimensional barcode with a database information about dosage types and doses of the said medicaments, and, in case of occurring prescription error, requesting a doctor who issued the prescription order to reconsider the previous prescription.

That is, the present inventor developed a method of requesting a doctor who issued a prescription order to reconsider dosage types and doses of prescribed medicaments, in case of occurring inappropriate prescription, which is realized by presenting to a pharmacy a prescription order on which dosage types and doses of medicaments are recorded in a form of two-dimensional barcode(hereinafter, occasionally referred to as “barcode-prescription order”), inputting the two-dimensional barcode printed in the prescription order into a computer, and confirming the occurrence of error in prescription data, where the two-dimensional barcode inputted into a computer is transformed into the information about dosage types and doses of medicaments, and compared with the database information about dosage types and doses of the prescribed medicaments so as to confirm whether the dosage types and doses of the prescribed medicaments are not in accord with those of the database information.

A method for monitoring error in prescription data employing barcode system in accordance with the present invention, comprises the steps of: (i) recording dosage type and dose of a medicament in a prescription order by way of encoding those in a form of barcode, after diagnosing a patient's disease condition by a doctor, and issuing a barcode-prescription order to the patient; (ii) inputting information recorded in the barcode-prescription order into a computer by using a barcode input device, and decoding the information in the barcode to transform it into the dosage type and dose of the medicament; (iii) comparing the information about the dosage type and dose of the medicament with a database information about the dosage type and dose of the said medicament, displaying the appropriateness of the dosage type and dose of the medicament in a message of “appropriate prescription” or “inappropriate prescription” on a monitor and/or a printer, and selecting the prescription displaying “inappropriate prescription”; and, (iv) requesting the doctor who issued the prescription order to reconsider the dosage type and dose in the selected prescription.

In carrying out the invented method, the step (ii) is preferably realized by using a barcode input device which is capable of inputting two-dimensional barcode on a barcode-prescription order into a computer, the step (iii) is preferably carried out by employing a computer system comprising a database information about the dosage type and dose of a prescribed medicament; an arithmetic program by which comparison of the information of a barcode-description with the database information is made to give the comparison results! and, a monitor and/or a printer on which the comparison results derived from the arithmetic program is displayed. In addition, the step (iii) may further comprise a step of making alert sound, sending warning message, or changing color on a monitor which can be easily recognized by a pharmacist in case of “inappropriate prescription”, and further comprise a step of displaying acceptable dosage type and dose of a prescribed medicament, and detailed information about inappropriate prescription in case of “inappropriate prescription”, and the step (iv) may further comprise a step of connecting to an on-line database containing detailed information about disease name, medicament which can be prescribed for the disease, acceptable dosage type and dose range of prescribed medicament, and confirming the appropriateness of dosage type and dose of a prescribed medicament again, prior to requesting the doctor to reconsider the dosage type and dose.

Barcode is an optical machine-readable representation of data comprising a specific combination of bars, space, cells and symbols, which are capable of recording letters, numbers and symbols. Barcode includes one-dimensional and two-dimensional barcode, and the latter is preferably employed for the present invention. Two-dimensional barcode has a data recording density 10 times more than one-dimensional barcode, and has functions such as security maintenance of recorded data, repair of partially damaged data, which are lacking in one-dimensional barcode. In a typical two-dimensional barcode, changes in dimension can be made depending on the capacity of recorded data and print form of barcode, and can record 1,000 letters in an area of 2.0 cm×2.0 cm.

Two-dimensional barcode has characteristics as follows: first, data storage and electronic transfer are very easy, since numerous data can be stored in a small area of barcode; secondly, symbolization and encodement of data allows security maintenance of important data; thirdly, data can be perfectly restored, even though it is partly (less than 30%) contaminated or damaged, which assures the stability of data storage; fourthly, the decodement of data in various directions and angles facilitates the user convenience; fifthly, the storabilty of various data including English letters, numbers, Hangeul (Korean letters), images and binary data, allows the expansion of expression way of documents! sixthly, the usage of a data management program suitably designed for barcode system can maximize the efficiency of business management.

In addition, barcode system has been developed for managing numerous data in a fast and accurate manner, in the area of goods screening, arrival and shipment of goods, management of stock and sales, medical service, and factory automation, by way of recording dispersed data and/or frequently used data in a barcode to resolve the problems that inputting data using a key board takes longer time than that using an arithmetic management and sometimes accompanies typographical errors.

Hereinafter, a method for monitoring error in prescription data employing barcode system of present invention is explained in more detail in conjunction with accompanying drawings.

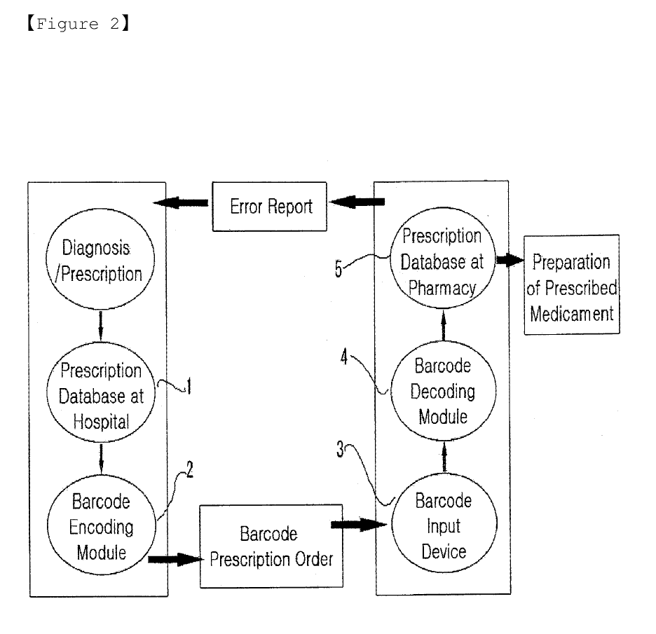

FIG. 2 is a schematic diagram depicting a total flow of monitoring error in prescription data employing barcode system in accordance with the present invention, which covers prescription database at hospital (1), barcode encoding module (2), barcode input device (3), barcode decoding module (4) and prescription database at pharmacy (5). The prescription database at hospital (1) is a database provided by a server at hospital, which saves prescription data including the patient's disease condition, and the barcode encoding module (2) is the means for recording such prescription data stored at the prescription database at hospital (1) in a barcode. Prescription data such as patient, medical institution, doctor and detailed prescriptions are recorded in the barcode, which is preferably encoded at two-dimensional barcode to save such informations. The barcode input device (3) scans barcode at a prescription order which is to be presented to pharmacy by a patient, the barcode decoding module (4) is a means for interpretating the information recorded at a barcode by using the barcode input device (3), the prescription database at pharmacy (5) saves the prescription data in a prescription order interpretated by the barcode decoding module (4). Preferably, the prescription database at hospital (1) and barcode encoding module (2) are included in a computer working at hospital, and the barcode input device (3), barcode decoding module (4) and the prescription database at pharmacy (5) are included in a computer working at pharmacy, respectively.

Again, referring to FIG. 2, a doctor diagnoses a patient at hospital and inputs prescription data including medicaments, their dosage types, doses, etc. in a prescription database at hospital (1), which is recorded at a prescription order by barcode encoding module (2) in a form of barcode. As a barcode containing prescription order is issued to a patient, the patient presents the prescription order to a pharmacy equipped with an optical machine which can read the barcode on the prescription order. At the pharmacy, the barcode information is inputted into a computer by subjecting the prescription order to a barcode input device (3), and the barcode information is sent to a barcode decoding module (4) to transform it into a prescription data which is recorded originally by doctor. The transformed data is sent to a prescription database at pharmacy (5), and, depending on the appropriateness of prescription, it is determined whether the prescribed medicament is provided to a patient or whether the prescription error is reported to a doctor who issued the prescription order to reconsider the previous prescription.

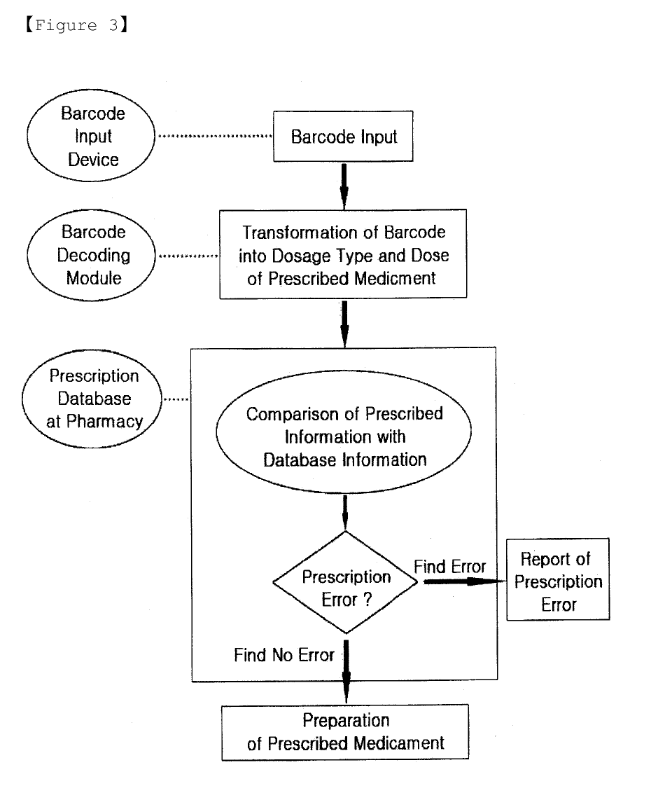

FIG. 3 is a flow diagram depicting a method for confirming the appropriateness of dosage type and dose of a medicament prescribed by a doctor: a barcode-prescription order presented by a patient is subjected to a barcode input device (3) to input barcode information, which is then sent to a barcode decoding module (4) to transform it into prescription data including prescribed medicaments, their dosage types, doses, etc. The transformed data is sent to a prescription database at pharmacy (5), and compared with the prescription data stored at the database to determine the appropriateness of dosage type and dose of a medicament prescribed by doctor. And then, if the prescription data is in accord with the database information and the prescription error is not found, such a result is displayed on an output device such as monitor or printer, and a pharmacist confirms it and provides a patient with medicaments prescribed by doctor. However, if the prescription data is not in accord with the database information and the prescription error is found, such a result is displayed on the output device, and a pharmacist reports it to a doctor who issued the prescription order and requests the doctor to reconsider the previous prescription.

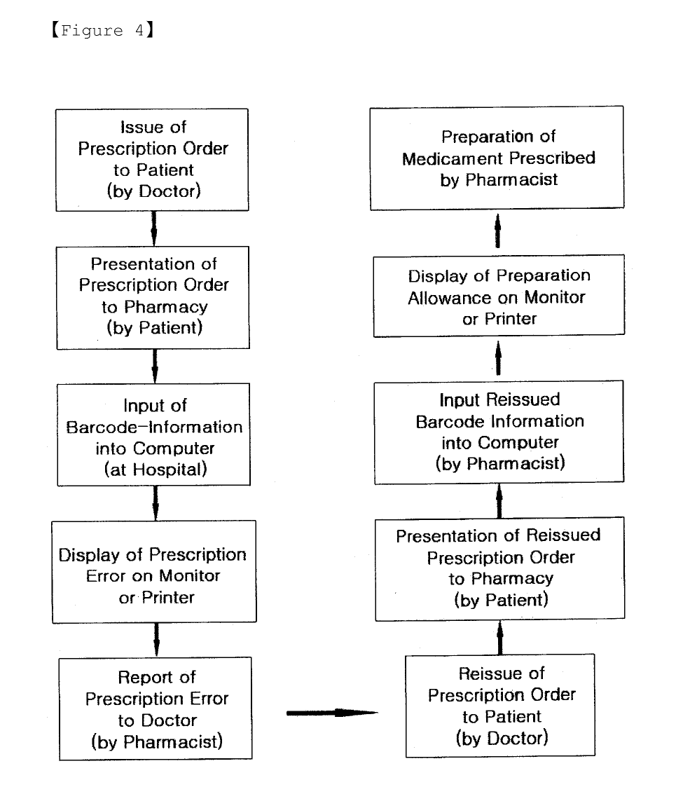

FIG. 4 is a schematic diagram showing an embodiment of a method for monitoring error recorded in prescription data employing barcode system in accordance with the present invention. As can be seen in FIG. 4, a doctor records the prescription data including diagnosed patient, disease name, dosage types and doses of prescribed medicaments, etc. in a form of barcode, and issues a barcode-prescription order to a patient. Then, the patient presents the prescription order issued by doctor to a pharmacy, and then a pharmacist inputs the information recorded in the prescription order into a computer by using a barcode input device, and, if the error in prescription data is found due to the inappropriateness of dosage types and doses of medicaments recorded at the prescription order, such a result is reported to a doctor who issued the said prescription order. Then, the doctor reconsiders the previous prescription and reissues the patient a prescription order in which the inappropriateness is duly corrected, and the patient presents the reissued prescription order to the pharmacy again. The pharmacist inputs the reissued prescription order into a computer by using a barcode input device, and if the appropriateness of the dosage types and doses of the prescribed medicaments is confirmed, the pharmacist provides the prescribed medicaments to the patient.

If the error is found in prescription data, the invented method may further comprise a step of making alert sound, sending warning message or changing color on a monitor which can be easily recognized by a pharmacist. And, the way of reporting such an error to the doctor includes, not limited thereto, a direct report where a pharmacist reports it to a doctor by using the contacting tool described in a prescription order and an indirect report where a pharmacist issues a written opinion to a patient and send it to a doctor.

On the other hand, in order to confirm the error in the prescription order issued by a doctor more accurately, prior to requesting the doctor to reconsider the prescription error, a pharmacist may connect to an on-line database containing the detailed prescription information such as disease names, medicaments which can be prescribed for the diseases, acceptable dosage types and dose ranges of prescribed medicaments and confirm the appropriateness of dosage types and doses of prescribed medicaments again. Preferably, the connectable on-line database includes the one provided by certified medicinal organizations to assure a reliability of the database.

As clearly illustrated and demonstrated as the above, the present invention provides a method for monitoring error in prescription data employing barcode system comprising the steps of recording the dosage type and dose of a medicament in a prescription order by encoding those in a form of barcode, inputting barcode information, comparing the inputted information with database information of the medicament so as to reconsider the appropriateness of the dosage type and dose of the prescribed medicament.

1. A method for monitoring error in prescription data employing barcode system which comprises the steps of:
(i) recording dosage type and dose of a medicament in a prescription order by way of encoding those in a form of barcode, after diagnosing a patient's disease condition by a doctor, and issuing a barcode-prescription order to the patient;
(ii) inputting information recorded in the barcode-prescription order into a computer by using a barcode input device, and decoding the information in the barcode to transform it into the dosage type and dose of the medicament;
(iii) comparing the information about the dosage type and dose of the medicament with a database information about the dosage type and dose of the said medicament, displaying the appropriateness of the dosage type and dose of the medicament in a message of “appropriate prescription” or inappropriate prescription” on a monitor and/or a printer, and selecting the prescription displaying “inappropriate prescription”; and,
(iv) requesting the doctor who issued the prescription order to reconsider the dosage type and dose in the selected prescription.

2. The method for monitoring error in prescription data employing barcode system of claim 1, wherein the barcode input device is capable of inputting two-dimensional barcode on a barcode-prescription order into a computer.

3. The method for monitoring error in prescription data employing barcode system of claim 1, wherein the step (iii) is carried out by using a computer system comprising a database information about the dosage type and dose of a prescribed medicament; an arithmetic program by which comparison of the information of a barcode-prescription order with the database information is made to give the comparison results; and, a monitor and/or a printer on which the comparison results derived from the arithmetic program is displayed.

4. The method for monitoring error in prescription data employing barcode system of claim 1, which further comprises a step of making alert sound, sending warning message, or changing color on a monitor which can be easily recognized by a pharmacist in case of “inappropriate prescription” in the step (iii).

5. The method for monitoring error in prescription data employing barcode system of claim 1, which further comprises a step of displaying acceptable dosage type and dose of a prescribed medicament, and detailed information about inappropriate prescription in case of “inappropriate prescription” in the step (iii).

6. The method for monitoring error in prescription data employing barcode system of claim 1, which further comprises a step of connecting to an on-line database containing detailed information about disease name, medicament which can be prescribed for the disease, acceptable dosage type and dose range of prescribed medicament, and confirming the appropriateness of dosage type and dose of a prescribed medicament again, prior to requesting the doctor to reconsider the dosage type and dose in the step (iv).
